(19) United States
(12) Patent Application Publication
(10) Pub. No.: US 2025/0234932 A1
(43) Pub. Date: Jul. 24, 2025

(54) AEROSOL-GENERATING DEVICE

(71) Applicant: KT&G CORPORATION, Daejeon (KR)

(72) Inventors: Jaemin LEE, Siheung-si Gyeonggi-do (KR); Hanseul RYU, Seoul (KR); Sangkyu PARK, Seoul (KR); Hwikyeong AN, Seoul (KR); Daenam HAN, Seoul (KR)

(73) Assignee: KT&G CORPORATION, Daejeon (KR)

(21) Appl. No.: 18/699,768

(22) PCT Filed: Oct. 12, 2022
(86) PCT No.: PCT/KR2022/015412

§ 371 Date: Apr. 9, 2024

(30) Foreign Application Priority Data
Oct. 29, 2021 (KR) 10-2021-0147015
Apr. 5, 2022 (KR) 10-2022-0042168

(51) Int. Cl. A24F 40/51; A24F 40/46; G01D 5/20; G01D 5/24

(52) U.S. Cl. CPC A24F 40/51; A24F 40/46; G01D 5/20; G01D 5/24

(57) ABSTRACT

An aerosol-generating device is disclosed. An aerosol-generating device comprising: a body comprising an insertion space; a heater configured to heat the insertion space; and a sensor installed in the body, wherein the sensor comprises: an inductive sensor comprising a planar sensing coil wound outwardly from a center of the sensing coil; and a capacitance sensor comprising a sensing electrode and disposed parallel and adjacent to the sensing coil to cover one side of the sensing coil.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another object of the present disclosure to implement various sensing functions through one sensor.

It is another object of the present disclosure to remove the noise without the need for a shielding material.

### Solution to Problem

In accordance with an aspect of the present disclosure for accomplishing the above and other objects, there is provided an aerosol-generating device including a body comprising an insertion space; a heater configured to heat the insertion space; and a sensor installed in the body, wherein the sensor comprises: an inductive sensor comprising a planar sensing coil wound outwardly from a center of the sensing coil; and a capacitance sensor comprising a sensing electrode and disposed parallel and adjacent to the sensing coil to cover one side of the sensing coil.

### Advantageous Effects of Invention

According to at least one of embodiments of the present disclosure, it is possible to implement various sensing functions through one sensor.

According to at least one of embodiments of the present disclosure, it is possible to remove the noise without the need for a shielding material.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features, and other advantages of the present disclosure will be more clearly understood from the following detailed description taken in conjunction with the accompanying drawings, in which:

FIGS. 1 to 13 are views showing examples of an aerosol-generating device according to embodiments of the present disclosure.

### MODE FOR THE INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

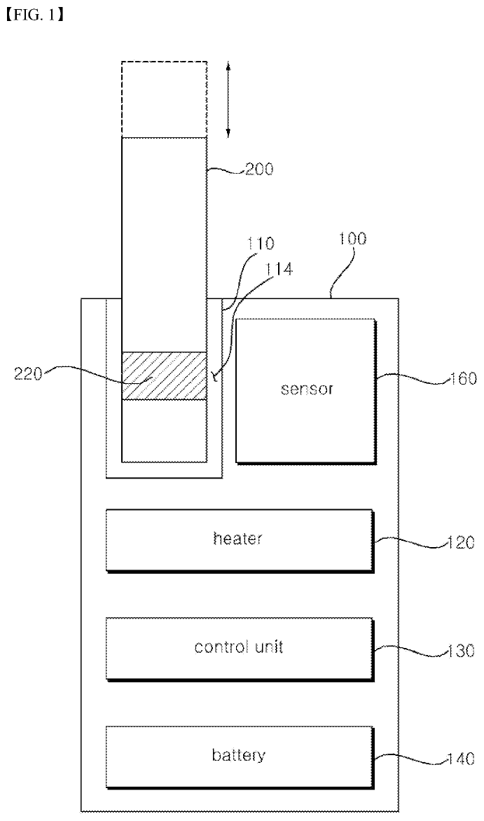

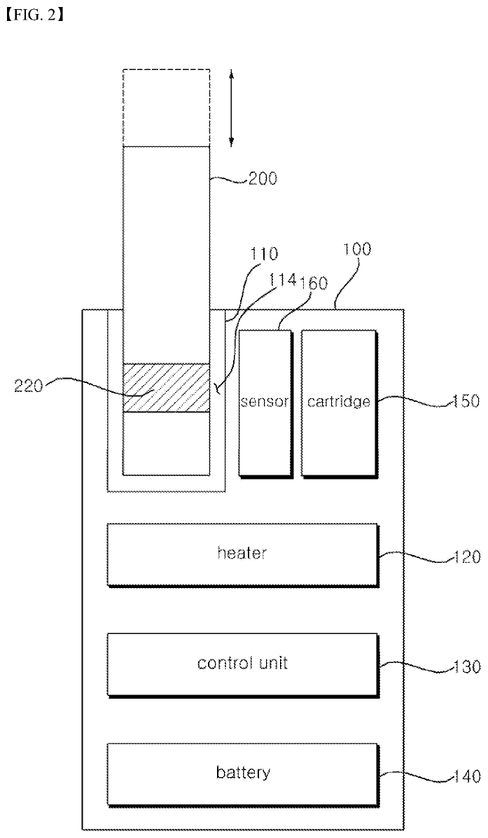

Referring to FIGS. 1 and 2, the aerosol-generating device may include a body 100. The body 100 may accommodate various components therein. The body 100 may include an insertion space 114. The pipe 110 may be formed inside the body 100. The pipe 110 may form an insertion space 114 therein. The insertion space 114 may be opened upward. The insertion space 114 may extend vertically. The stick 200 may be inserted into the insertion space 114. The stick 200 may include an aerosol-generating material therein. The stick 200 may be called a cigarette 200 or an aerosol-generating article 200.

The aerosol-generating device may include a heater 120. The heater 120 may be disposed inside the body 100. The heater 120 may be disposed around the insertion space 114. The heater 120 may surround the insertion space 114. As another example, the heater 120 may protrude from the insertion space 114. When the stick 200 is inserted into the insertion space 114, the heater 120 may be inserted into the stick 200. As another example, the heater 120 is disposed inside the stick 200 to be integrally formed with the stick 200, and may be induction heated by an induction coil (not shown) around the insertion space 114. The heater 120 may be an electrically resistive heater or an induction heating heater. The heater 120 may heat the insertion space 114. The heater 120 may heat the stick 200. The stick 200 may be heated by the heater 120 to vaporize the aerosol generating material inside and generate an aerosol.

The aerosol-generating device may include a control unit 130. The control unit 130 may be disposed inside the body 100. The control unit 130 may control the overall operation of the aerosol-generating device components. The control unit 130 may control the operation of the heater 120, the battery 140, the cartridge 150, the sensor 160, as well as other components included in the aerosol-generating device. For example, the control unit 130 may control the operation of a display installed in the aerosol-generating device, a motor, and the like. The control unit 130 may include at least one processor. The processor may be implemented as an array of a plurality of logic gates, or may be implemented as a combination of a general-purpose microprocessor and a memory in which a program executable in the microprocessor is stored. In addition, it can be understood by those of ordinary skill in the art to which this embodiment pertains that it may be implemented in other types of hardware.

The aerosol-generating device may include a battery 140. The battery 140 may be disposed inside the body 100. The battery 140 may supply power used to operate various components of the aerosol-generating device. For example, the battery 140 may supply power so that the heater 120 generates heat. As another example, the battery 140 may supply power to operate the control unit 130. As another example, the battery 140 may supply power to operate the sensor 160. As another example, the battery 140 may supply power required to operate a display, a motor, etc. installed in the aerosol-generating device.

The aerosol-generating device may further include a cartridge 150. The cartridge 150 may be disposed at one side of the body 100. The cartridge 150 may be detachably coupled to one side of the body 100. The cartridge 150 may be disposed adjacent to the pipe 110. The cartridge 150 may be arranged in parallel with the insertion space 114. The cartridge 150 may be disposed in parallel with the insertion space 114.

The cartridge 150 may generate an aerosol by heating the liquid composition, and the generated aerosol may be delivered to the user through the stick 200. In other words, the aerosol generated by the cartridge 150 may move along the airflow path of the aerosol-generating device, and the airflow path allows the aerosol generated by the cartridge 150 to pass through the stick 200 and be delivered to the user. When the aerosol-generating device includes the cartridge 150, the heater 120 may be omitted.

For example, the cartridge 150 may include, but is not limited to, a liquid reservoir, a liquid delivery means, and a heating element. For example, the liquid reservoir, liquid delivery means and heating element may be included in the aerosol-generating device as independent modules.

The liquid reservoir may store the liquid composition. For example, the liquid composition may be a liquid comprising a tobacco-containing material comprising a volatile tobacco flavor component, or may be a liquid comprising a non-tobacco material. The liquid reservoir may be manufactured to be detachably from the cartridge 150, or may be manufactured integrally with the cartridge 150.

For example, the liquid composition may include water, a solvent, ethanol, a plant extract, a flavoring, flavoring agent, or a vitamin mixture. The fragrance may include, but is not limited to, menthol, peppermint, spearmint oil, various fruit flavoring ingredients, and the like. Flavoring agents may include ingredients capable of providing a user with a variety of flavors or flavors. The vitamin mixture may be a mixture of at least one of vitamin A, vitamin B, vitamin C, and vitamin E, but is not limited thereto. Liquid compositions may also include aerosol formers such as glycerin and propylene glycol.

The liquid delivery means may deliver the liquid composition of the liquid reservoir to the heating element. For example, the liquid delivery means may be, but is not limited to, a wick such as cotton fiber, ceramic fiber, glass fiber, or porous ceramic.

The heating element is an element for heating the liquid composition delivered by the liquid delivery means. For example, the heating element may be a metal heating wire, a metal heating plate, a ceramic heater, or the like, but is not limited thereto. Further, the heating element may be composed of a conductive filament such as a nichrome wire, and may be arranged in a structure wound around the liquid delivery means. The heating element may be heated by applying an electrical current, and may transfer heat to the liquid composition in contact with the heating element, thereby heating the liquid composition. As a result, an aerosol may be generated.

For example, the cartridge 150 may be referred to as a cartomizer or an atomizer, but is not limited thereto.

Meanwhile, the aerosol-generating device may further include general-purpose components in addition to the battery 140, the control unit 130, and the cartridge 150. For example, the aerosol-generating device may further include an induction coil (not shown) for heating the heater 120 by the induced current. As another example, the aerosol-generating device may include a display capable of outputting visual information and/or a motor for outputting tactile information. In addition, the aerosol-generating device may include at least one sensor (a puff detection sensor, a temperature sensor, a cigarette insertion detection sensor, etc.). In addition, the aerosol-generating device may be manufactured in a structure that allows external air to flow in or internal gas to flow out even in a state in which the cigarette 200 is inserted.

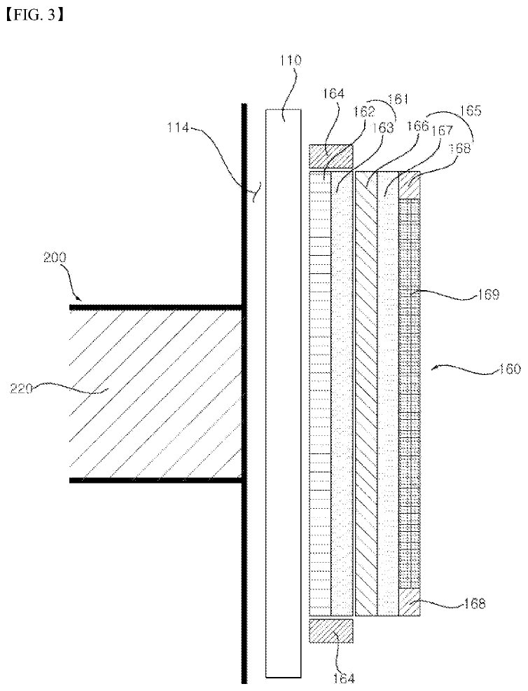

The aerosol-generating device may include a sensor 160. The sensor 160 may be installed on the body 100. The sensor 160 may include an inductive sensor 161 (refer to FIG. 3) that senses a change in inductance around it. The sensor 160 may include a capacitance sensor 165 (refer to FIG. 3) that senses a change in capacitance around it. The sensor 160 may be disposed adjacent to the insertion space 114. The sensor 160 may be disposed adjacent to one side of the pipe 110. The sensor 160 may be directed toward the insertion space 114. The sensor 160 may be disposed between the insertion space 114 and the cartridge 160. One surface of the sensor 160 may face toward the insertion space 114, and the other surface of the sensor 160 may face toward the cartridge 160. The sensor 160 may detect whether the stick 400 is inserted into the insertion space 114, whether the inserted stick 400 is a set dedicated stick 400, the degree to which the stick 400 is used, and the like. The sensor 160 may transmit the sensed information to the control unit 130.

The internal structure of the aerosol-generating device is not limited to that shown in the drawings. In other words, the arrangement of the heater 120, the control unit 130, the battery 140, the cartridge 150, the sensor 160, etc. according to the design of the aerosol-generating device is not limited to that shown in the drawings, it can be changed.

The user may inhale the aerosol while biting a part of the stick 200 protruding from the insertion space 114 to the outside. At this time, the aerosol may be generated while external air passes through the stick 200, and the generated aerosol may pass through the stick 200 and be delivered to the user's mouth.

As an example, external air may be introduced through at least one air passage formed in the aerosol-generating device. For example, the opening and closing of the air passage and/or the size of the air passage formed in the aerosol-generating device may be adjusted by the user. Accordingly, the amount of atomization, the feeling of smoking, and the like can be adjusted by the user. As another example, external air may be introduced into the inside of the stick 200 through at least one hole formed in the surface of the stick 200.

Hereinafter, the substrate or the ground portion shown in FIGS. 3, 6, 9 and 12 is illustrated and described to help the understanding of the invention, and is not intended to limit the configuration or arrangement of the capacitance sensor or the inductive sensor. The capacitance sensor is only an example of a capacitance sensor that can be implemented, and is not limited to the illustrated configuration or arrangement of the capacitance sensor. The capacitance sensor may be a self-capacitance sensor or a mutual capacitance sensor. The illustrated capacitance sensor is an example of a self-capacitance sensor, but the capacitance sensor may be a mutual capacitance sensor, unlike the illustration. In addition, in the case of the inductive sensor and the sensing coil shown in FIGS. 3, 6, 9 and 12, it is only an example of a possible configuration of the inductive sensor, and is not limited to the configuration or arrangement of the illustrated inductive sensor. Except for the arrangement and shape of the sensing coil of the inductive sensor and the sensing electrode of the capacitance sensor, it is obvious that the arrangement of the substrate can be changed.

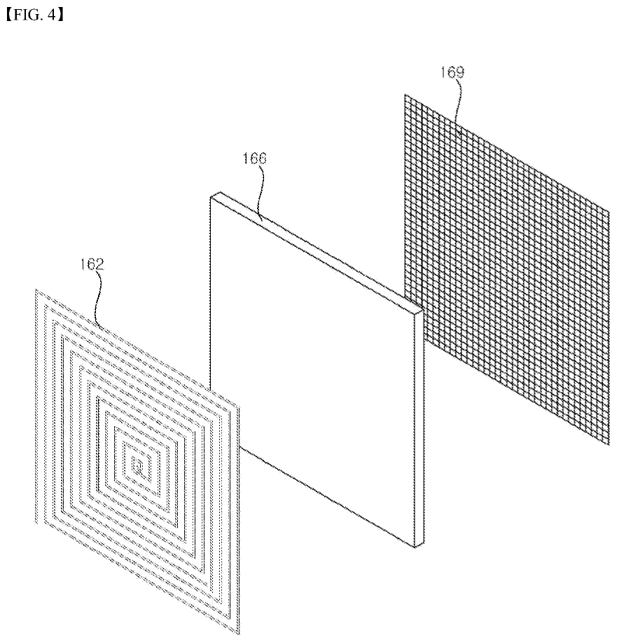

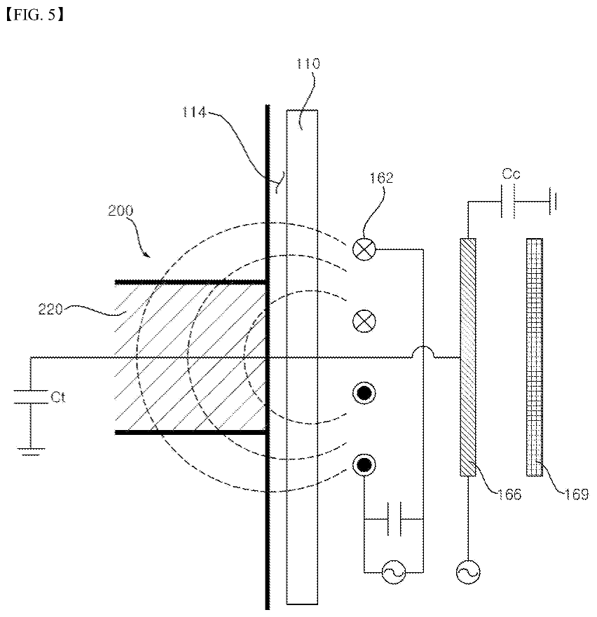

Referring to FIGS. 3 to 5, the sensor 160 performs the functions of the inductive sensor 161 and the capacitance sensor 165 at the same time, so that different detection can be performed, and the introduction of external noise can be prevented. Hereinafter, this will be described.

The sensor 160 may be disposed inside the body 100. The sensor 160 may be disposed on the outside of the pipe 110 and adjacent to the pipe 110. The sensor 160 may be directed toward one side of the pipe 10. The arrangement of the sensor 160 is not limited thereto.

The sensor 160 may detect the stick 200 inserted into the insertion space 114. The stick 200 may include a metal material. For example, the stick 200 may include a marker 220 in the form of a thin metal film surrounding an external wrapper. The sensor 160 may detect a change in capacitance and/or a change in inductance, and transmit information to the control unit 130. The control unit 130 receives information from the sensor 160 to determine whether the stick 200 is inserted into the insertion space 114 or whether the stick 200 inserted into the insertion space 114 is a set dedicated stick 200 or whether the stick 200 inserted in the insertion space 114 is used or not, etc.

The sensor 160 may include an inductive sensor 161. The sensor 160 may include a capacitance sensor 165. The inductive sensor 161 and the capacitance sensor 165 may be disposed adjacent to each other. The inductive sensor 161 and the capacitance sensor 165 may be arranged side by side or facing each other.

The capacitance sensor 165 may include a sensing electrode 166. The sensing electrode 166 may be formed of a metal having conductivity. The capacitance sensor 165 may include a substrate 167. A sensor for detecting a change in capacitance of the sensing electrode 166 may be mounted on the substrate 167. The sensor of the substrate 167 may be electrically connected to the sensing electrode 166. The sensing electrode 166 may be printed or mounted on the substrate 167. Alternatively, it may be spaced apart from the substrate 167 and electrically connected to the sensor. The capacitance sensor 165 may include a ground portion 168. The ground portion 168 may be mounted on the substrate 167 or printed. The ground portion 168 may be directed toward the sensing electrode 166 to ground the sensing electrode 166. The substrate 167 may be a PCB, an FPCB, or the like, but is not limited thereto.

The sensing electrode 166 may be a self-capacitance sensor. The sensing electrode 166 may have a rectangular shape. The sensing electrode 166 may be formed of a metal thin film. For example, the sensing electrode 166 may be a copper foil or a copper foil. When the capacitance sensor 165 is a self-capacitance sensor, the sensing electrode 166 is a metal pad and may serve as one parallel plate, and the stick 200 inserted into the insertion space 114 may serve as another parallel plate.

As another example, the sensing electrode 166 may be a mutual capacitance sensor. In this case, for example, the sensing electrode 166 may comprise a transmitting electrode and a receiving electrode facing each other.

The capacitance sensed by the capacitance sensor 165 may be a changed, depending on whether the stick 200 is inserted into the insertion space 114. Alternatively, the capacitance sensed by the capacitance sensor 165 may be changed, depending on the type of the stick 200 inserted into the insertion space 114. For example, the type of metal material of the marker 220 or whether the marker 220 is provided may be different depending on the type of the stick 200, and accordingly, the change in the capacitance sensed by the capacitance sensor 165 may occur. Accordingly, the capacitance sensor 165 may sense what kind of stick 200 is inserted into the insertion space 114. Alternatively, when the stick 200 inserted into the insertion space 114 is used, the capacitance sensed by the capacitance sensor 165 may be changed, depending on the degree of use of the stick 200. For example, as the stick 200 is used, the amount of moisture contained in the stick 200 may vary, and accordingly, a change in capacitance sensed by the capacitance sensor 165 may occur. Accordingly, the capacitance sensor 165 may determine the degree to which the stick 200 inserted into the insertion space 114 is used, or determine whether the stick 200 is being puffed. The control unit 130 may store capacitance values for each state in advance through a memory.

The inductive sensor 161 may include a sensing coil 162. The sensing coil 162 may be formed of a conductive metal. The sensing coil 162 may be referred to as an inductance coil 162. The inductive sensor 161 may include a substrate 163 having a sensor for detecting a change in inductance. The inductive sensor 161 may be mounted on the substrate 163 or printed. Alternatively, the inductive sensor 161 may be electrically connected while being spaced apart from the substrate 163. The substrate 163 may be a PCB, an FPCB, or the like, but is not limited thereto. The substrate 163 may be spaced apart from the sensing coil 162 to be electrically connected without necessarily being arranged in parallel with the capacitance sensor 165 as shown.

When the magnetic field changes around the sensing coil 162 through which the current flows according to electromagnetic induction, the characteristics of the current flowing through the sensing coil 162 may be changed. Depending on whether the stick 200 is inserted into the insertion space 114, the current flowing in the sensing coil 162 may induce an eddy current in the marker 220 of the stick 200. The eddy current flowing through the marker 220 may change characteristics of the current such as the frequency of the current flowing through the sensing coil 162 and the inductance value of the coil, etc. through mutual induction with the sensing coil 162 again. The inductive sensor 161 may detect a change in a characteristic value of a current flowing through the sensing coil 162 or a change in inductance. The inductive sensor 161 may transmit information on the sensed inductance to the control unit 130. The control unit 130 may determine whether the stick 200 is inserted into the insertion space 114 or the type of the stick 200 inserted into the insertion space 114 according to the inductance information received from the inductive sensor 161. The control unit 130 may store inductance values according to each state in advance through a memory.

Since the capacitance sensor 165 responds more sensitively to a change in humidity than the inductive sensor 161, so the capacitance sensor 165 may be more specialized in determining the extent to which the stick 200 is used or whether the stick 200 is puffed. Since the inductive sensor 161 responds more sensitively to the movement of a material having high magnetic permeability than the capacitance sensor 165, so the inductive sensor 161 may be specialized in determining whether the stick 200 is inserted into the insertion space 114 or the type of the stick 200 inserted into the insertion space 114.

The sensing coil 162 may be disposed to face toward the pipe 110 and/or the insertion space 114. The sensing electrode 166 may be disposed to face toward the pipe 110 and/or the insertion space 114. The sensing coil 162 may be disposed between the insertion space 114 and the sensing electrode 166. The sensing coil 162 may be adjacent to the insertion space 114 than the sensing electrode 166.

The sensing coil 162 may be wound to expand radially outward from the central axis. The central axis of the sensing coil 162 may be directed toward the insertion space 114. The sensing coil 162 may overlap the front surface of the capacitance sensor 165. The sensing electrode 166 of the capacitance sensor 165 may overlap the rear surface of the sensing coil 162. The capacitance sensor 165 may cover the rear surface of the sensing coil 162. The sensing coil 162 and the sensing electrode 166 may be arranged side by side or facing each other. shape of perimeter of the sensing coil 162 and shape of perimeter of the sensing electrode 166 may be corresponded to each other. For example, the perimeter shape of the sensing coil 162 and the sensing electrode 166 may have a rectangular shape. Accordingly, the sensing coil 162 and the sensing electrode 166 may cover each other.

When the sensing coil 162 is wound relatively densely with a small separation width, since the sensing coil 162 may shield the electric field flowing into the capacitance sensor 165, it is interfered that the capacitance sensor 165 senses the change in the capacitance around the insertion space 114. Accordingly, the sensing coil 162 may be wound relatively loosely with a predetermined separation width so as not to shield the capacitance sensor 165 from sensing the insertion space 114.

Accordingly, the capacitance sensor 165 and the inductive sensor 161 may simultaneously perform various different sensing functions in one sensor 160. In addition, since the capacitance sensor 165 shields the magnetic field, it is possible to prevent noise from being generated in the inductive sensor 161 from the outside. It is an exemplary embodiment that the sensor 160 senses the insertion space 114, but the sensing target is not limited thereto.

The sensor 160 may surround the pipe 110. The sensor 160 may have a cylindrical shape. The substrates 163 and 162 of the sensor 160 may include an FPCB.

The sensor 160 may further include a shielding ring 164. The shielding ring 164 may surround the inductive sensor 161. The shielding ring 164 may extend along the circumference of the sensing coil 161 in a direction in which the sensing coil 161 is wound. The shielding ring 164 may shield the magnetic field from the inductive sensor 161 and collect the direction of the magnetic field into the insertion space 114. For example, the shielding ring 164 may be formed of a material such as ferrite, nanocrystal, or a metal material, etc. However, the material of the shielding ring 164 is not limited thereto.

The sensor 160 may further include a shielding member 169. The shielding member 169 may overlap the rear of the capacitance sensor 165. The shielding member 169 may be, for example, a conductive material such as aluminum and copper, or a carbon material such as carbon fiber or carbon nanotube, etc. The shielding member 169 may shield noise from the rear side of the capacitance sensor 165. The shielding member 169 may have a porous metal mesh shape. The shielding member 169 may have a mesh shape. When the shielding member 169 has a porous mesh shape, the capacitance is relatively lower than that of the metal plate, and thus, the shielding member 169 can be disposed closer to the capacitance sensor 165 than the metal foil. Accordingly, the shielding member 169 may be printed on the rear side of the substrate 167 and may be integrally formed with the capacitance sensor 165.

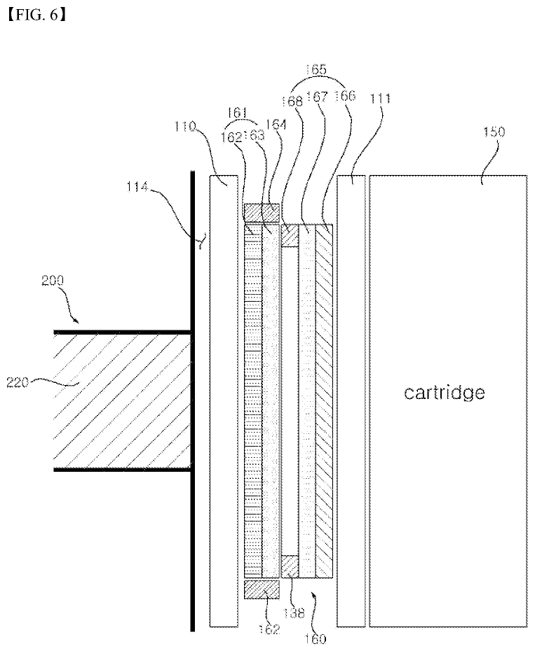

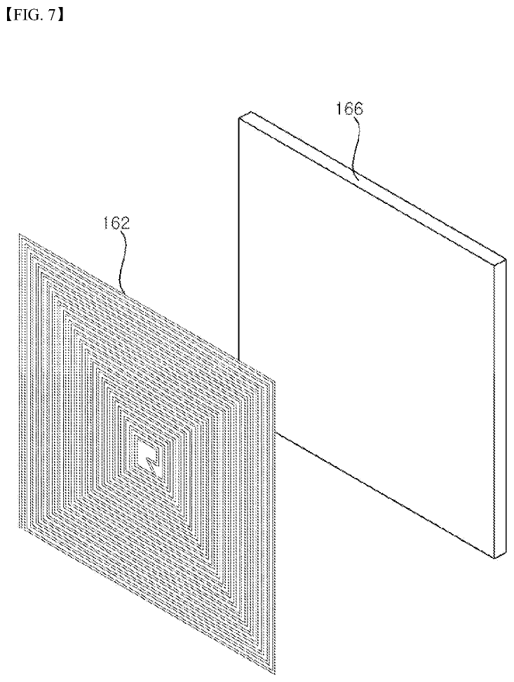

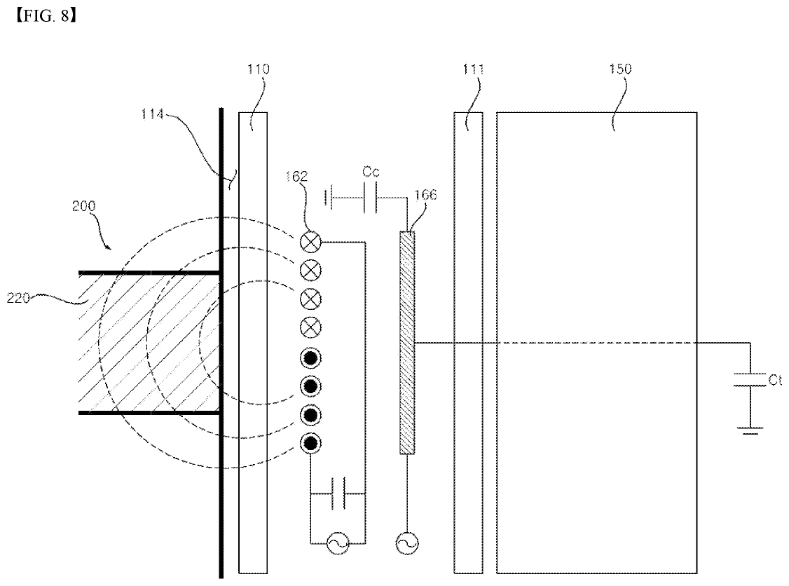

Referring to FIGS. 6 to 8, in the sensor 160, the shielding member 169 may be omitted in the embodiments of FIGS. 3 to 5. The body 100 (see FIGS. 1 and 2) may further include a partition wall 111. The partition wall 111 may be spaced apart from the pipe 110 at a predetermined interval. For example, the pipe 110 and the partition wall 111 may extend long in the vertical direction. The cartridge 150 may be coupled to the partition wall 111. The cartridge 150 may be disposed in parallel with the pipe 110. The sensor 160 may be disposed between the pipe 110 and the partition wall 111. The sensor 160 may be disposed between the insertion space 114 and the cartridge 150.

The inductive sensor 161 and the capacitance sensor 165 may direct toward different directions. For example, the inductive sensor 161 may be directed toward the insertion space 114, and the capacitance sensor 165 may be directed toward the cartridge 150. As another example, the inductive sensor 161 may be directed toward the cartridge 150, and the capacitance sensor 165 may be directed toward the insertion space 114.

The sensing coil 162 of the inductive sensor 161 may be wound relatively tightly to shield the electric field flowing into the capacitance sensor 165 from the insertion space 114 side. At this time, the sensing coil 162 may perform the same role as the metal shielding member in which the perforated hole is formed.

Accordingly, the inductive sensor 161 may sense whether the stick 200 is inserted into the insertion space 114 and the type of the stick 200 inserted into the insertion space 114 through inductance change. In addition, the capacitance sensor 165 may sense whether the cartridge 150 is mounted on the body 100 and the amount of the liquid stored in the cartridge 150 through capacitance change.

Accordingly, the sensing coil 162 may shield the capacitance sensor 165 from external noise and prevent noise from being introduced into the capacitance sensor 165 from the insertion space 114 side. In addition, the sensing electrode 166 of the capacitance sensor 165 may shield the inductance coil 161 from external noise, thereby being able to prevent noise from being introduced toward the inductive sensor 161 from the cartridge 150 side.

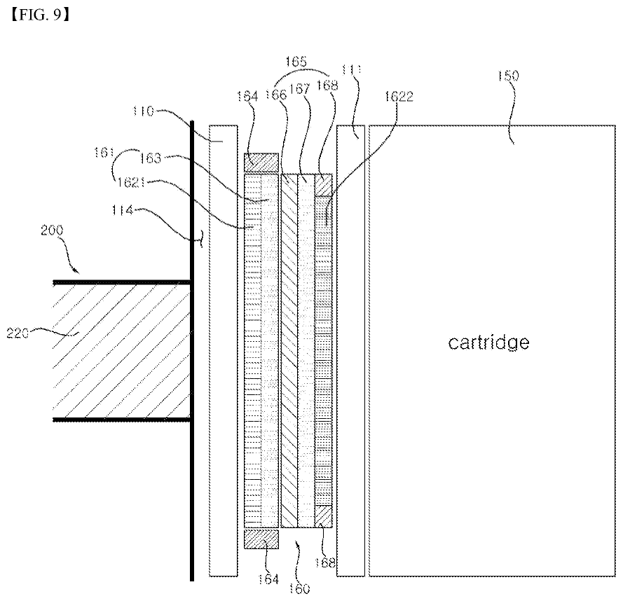

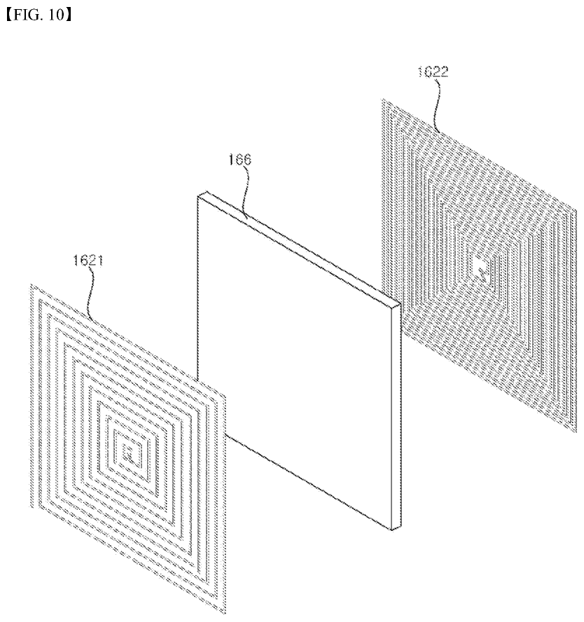

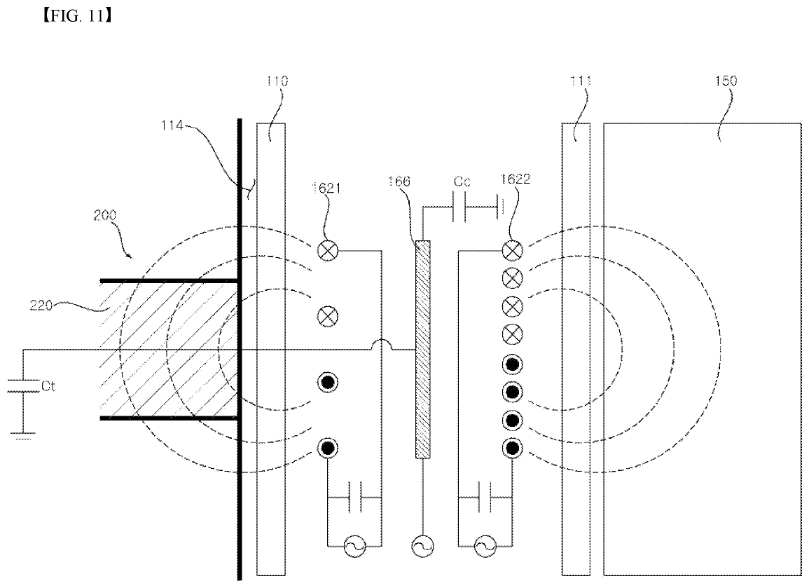

Referring to FIGS. 9 to 11, the first inductive sensor 161 may include a first sensing coil 1621 and a substrate 163. The substrate 163 is not necessarily disposed to face toward the capacitance sensor 165 as shown. The first sensing coil 1621 and the capacitance sensor 165 may face each other or may be disposed in parallel with each other. The second inductive sensor 161′ may include a second sensing coil 1622. The second sensing coil 1622 may be mounted or printed on the substrate 167 of the capacitance sensor 165. In this case, a sensor for sensing a change in inductance through the second sensing coil 1622 may be mounted or printed on the substrate 167. In this case, the second inductive sensor 161′ may include a second sensing coil 1622 and a substrate 167 on which a sensor sensing a change in inductance of the second sensing coil 1622 is mounted. This is only an example, and it is obvious that the second sensing coil 1622 may be coupled to another substrate other than the substrate of the capacitance sensor 165.

The sensor 160 may be disposed between the insertion space 114 and the space in which the cartridge 150 is located. The capacitance sensor 165 may be disposed between a pair of first sensing coils 1621 and second sensing coils 1622. The first sensing coil 1621 may cover one surface of the capacitance sensor 165, and the second sensing coil 1622 may cover the other surface of the capacitance sensor 165. The first sensing coil 1621, the second sensing coil 1622, and the sensing electrode 166 may be arranged side by side or facing each other. The first sensing coil 1621 and the sensing electrode 166 may face toward one side, and the second sensing coil 1622 may face toward the other side. For example, the first sensing coil 1621 and the sensing electrode 166 may face toward the insertion space 114, and the second sensing coil 1622 may face toward the cartridge 150. The first sensing coil 1621 and the second sensing coil 1622 may be wound to expand radially outward with respect to the central axis.

The first sensing coil 1621 may have a smaller number of turns than the second sensing coil 1622. The width of the first sensing coil 1621 wound at a predetermined interval may be greater than that of the second sensing coil 1622. The first sensing coil 1621 may not relatively shield the capacitance sensor 165 compared to the second sensing coil 1622, and the second sensing coil 1622 may shield the capacitance sensor 165. That is, the inductive sensor may sense the amount of change in inductance from the insertion space 114 side through the first sensing coil 1621, and sense the amount of change in inductance from the cartridge 150 side through the second sensing coil 1622. In addition, the capacitance sensor may sense the amount of change in capacitance from the axis of the insertion space 114 through the sensing electrode 166.

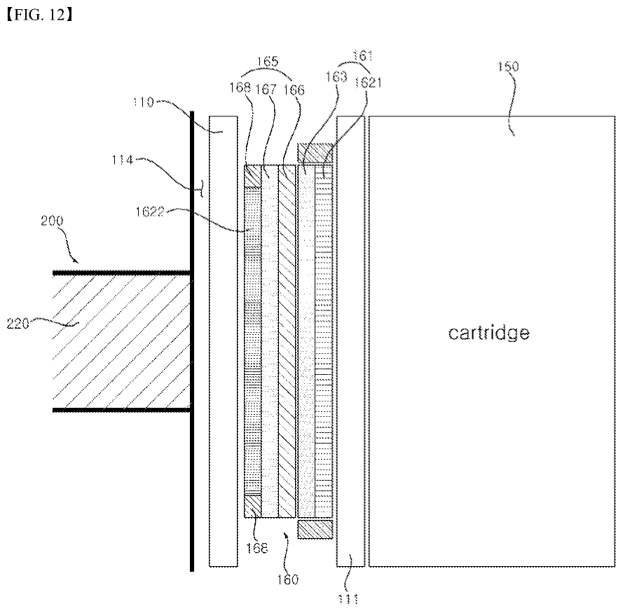

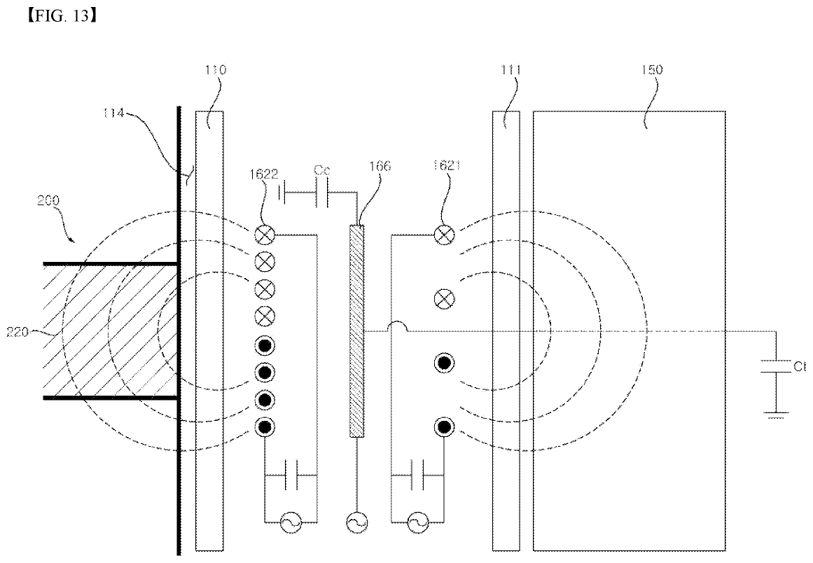

Referring to FIGS. 12 and 13, the first sensing coil 1621 and the sensing electrode 166 may face toward the cartridge 150, and the second sensing coil 1622 may face toward the insertion space 114. the inductive sensor may sense the amount of change of inductance from the cartridge 150 side through the first sensing coil 1621, and may sense the amount of change of inductance from the insertion space 114 side through the second sensing coil 1622. In addition, the capacitance sensor may sense the amount of change in capacitance from the cartridge 150 side through the sensing electrode 166.

Referring to FIGS. 1 to 13, An aerosol-generating device comprising: a body comprising an insertion space; a heater configured to heat the insertion space; and a sensor installed in the body, wherein the sensor comprises: an inductive sensor comprising a planar sensing coil wound outwardly from a center of the sensing coil; and a capacitance sensor comprising a sensing electrode and disposed parallel and adjacent to the sensing coil to cover one side of the sensing coil.

In addition, in accordance with another aspect of the present disclosure, wherein the sensing coil and the sensing electrode may be disposed to face toward the insertion space and the sensing coil is disposed between the insertion space and the sensing electrode; wherein the capacitance sensor may be configured to sense a change in capacitance of the insertion space; and wherein the inductive sensor may be configured to sense a change in inductance of the insertion space.

In addition, in accordance with another aspect of the present disclosure, wherein the sensing electrode may shield the sensing coil from magnetic fields.

In addition, in accordance with another aspect of the present disclosure, the aerosol-generating device may further comprising a shielding member disposed opposite to the inductive sensor with respect to the capacitance sensor, and covering one side of the capacitance sensor.

In addition, in accordance with another aspect of the present disclosure, the aerosol-generating device may further comprising a cartridge coupled to the body to be adjacent to the insertion space, wherein the sensor may be disposed between the insertion space and the cartridge, wherein the sensing coil faces toward one of the insertion space or the cartridge and the sensing electrode faces toward the other one of the insertion space or the cartridge, wherein the inductive sensor may be configured to sense a change in inductance, and wherein the capacitance sensor may be configured to sense a change in capacitance.

In addition, in accordance with another aspect of the present disclosure, wherein the sensing coil is wound to provide electric shielding for the sensing electrode from electric fields wherein the sensing electrode provides magnetic shielding for the sensing coil from magnetic fields.

In addition, in accordance with another aspect of the present disclosure, the aerosol-generating device may further comprising a cartridge coupled to the body to be adjacent to the insertion space, wherein the sensor is disposed between the insertion space and the cartridge, wherein the inductive sensor further comprises: a first inductive sensor including a first sensing coil; and a second inductive sensor including a second sensing coil arranged parallel to the first sensing coil, wherein the sensing electrode is disposed between the first sensing coil and the second sensing coil.

In addition, in accordance with another aspect of the present disclosure, wherein the first sensing coil and the second sensing coil are each planarly wound, and a spacing between turns of the first sensing coil is larger than a spacing between turns of the second sensing coil.

In addition, in accordance with another aspect of the present disclosure, wherein the first inductive sensor is configured to sense a change in inductance of the insertion space through the first sensing coil, wherein the capacitance sensor is configured to sense a change in capacitance of the insertion space through the sensing electrode, and wherein the second inductive sensor is configured to sense a change in inductance of the cartridge through the second sensing coil.

In addition, in accordance with another aspect of the present disclosure, wherein the first inductive sensor is configured to sense a change in inductance of the cartridge through the first sensing coil, wherein the capacitance sensor is configured to sense a change in capacitance of the cartridge through the sensing electrode, and wherein the second inductive sensor is configured to sense a change in inductance of the insertion space through the second sensing coil.

In addition, in accordance with another aspect of the present disclosure, wherein the sensing electrode and the sensing coil may have perimeter shapes corresponding to each other.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a body comprising an insertion space;
a heater configured to heat the insertion space; and
a sensor installed in the body,
wherein the sensor comprises:
an inductive sensor comprising a planar sensing coil wound outwardly from a center of the sensing coil; and
a capacitance sensor comprising a sensing electrode and disposed parallel and adjacent to the sensing coil to cover one side of the sensing coil.

2. The aerosol-generating device according to claim 1,
wherein the sensing coil and the sensing electrode are disposed to face toward the insertion space and the sensing coil is disposed between the insertion space and the sensing electrode;
wherein the capacitance sensor is configured to sense a change in capacitance of the insertion space; and
wherein the inductive sensor is configured to sense a change in inductance of the insertion space.

3. The aerosol-generating device according to claim 2, wherein the sensing electrode shields the sensing coil from magnetic fields.

4. The aerosol-generating device according to claim 2, further comprising a shielding member disposed opposite to the inductive sensor with respect to the capacitance sensor, and covering one side of the capacitance sensor.

5. The aerosol-generating device according to claim 1, further comprising a cartridge coupled to the body to be adjacent to the insertion space,
wherein the sensor is disposed between the insertion space and the cartridge,
wherein the sensing coil faces toward one of the insertion space or the cartridge and the sensing electrode faces toward the other one of the insertion space or the cartridge,
wherein the inductive sensor is configured to sense a change in inductance, and
wherein the capacitance sensor is configured to sense a change in capacitance.

6. The aerosol-generating device according to claim 5,
wherein the sensing coil is wound to provide electric shielding for the sensing electrode from electric fields
wherein the sensing electrode provides magnetic shielding for the sensing coil from magnetic fields.

7. The aerosol-generating device according to claim 5, further comprising a cartridge coupled to the body to be adjacent to the insertion space,
wherein the sensor is disposed between the insertion space and the cartridge,
wherein the inductive sensor further comprises:
a first inductive sensor including a first sensing coil; and
a second inductive sensor including a second sensing coil arranged parallel to the first sensing coil,
wherein the sensing electrode is disposed between the first sensing coil and the second sensing coil.

8. The aerosol-generating device according to claim 7, wherein the first sensing coil and the second sensing coil are each planarly wound, and a spacing between turns of the first sensing coil is larger than a spacing between turns of the second sensing coil.

9. The aerosol-generating device according to claim 8,
wherein the first inductive sensor is configured to sense a change in inductance of the insertion space through the first sensing coil,
wherein the capacitance sensor is configured to sense a change in capacitance of the insertion space through the sensing electrode, and
wherein the second inductive sensor is configured to sense a change in inductance of the cartridge through the second sensing coil.

10. The aerosol-generating device according to claim 8,
wherein the first inductive sensor is configured to sense a change in inductance of the cartridge through the first sensing coil,
wherein the capacitance sensor is configured to sense a change in capacitance of the cartridge through the sensing electrode, and
wherein the second inductive sensor is configured to sense a change in inductance of the insertion space through the second sensing coil.

11. The aerosol-generating device according to claim 1, wherein the sensing electrode and the sensing coil have perimeter shapes corresponding to each other.
